(19) United States
(12) Patent Application Publication
(10) Pub. No.: US 2015/0267750 A1
(43) Pub. Date: Sep. 24, 2015

(54) BEARING DEVICE FOR WHEEL

(71) Applicant: JTEKT CORPORATION, Osaka (JP)

(72) Inventor: Yoshiyuki INA, Osaka-shi (JP)

(21) Appl. No.: 14/636,786

(22) Filed: Mar. 3, 2015

(30) Foreign Application Priority Data
Mar. 24, 2014 (JP) 2014-059877

(51) Int. Cl. F16C 33/58; B60B 27/00; F16C 19/08

(52) U.S. Cl. CPC F16C 33/585; F16C 19/08; B60B 27/0005

(57) ABSTRACT

In a wheel bearing device including double ball rows, in a rotary raceway surface associated with the ball row on a vehicle outer side, a generatrix on a contact angle side has a circular arc shape, and the height of a shoulder on the vehicle outer side of the rotary raceway surface is larger than the curvature radius of the circular arc portion.

### INCORPORATION BY REFERENCE

The disclosure of Japanese Patent Application No. 2014-059877 filed on Mar. 24, 2014 including the specification, drawings and abstract, is incorporated herein by reference in its entirety.

### BACKGROUND OF THE INVENTION

1. Field of the Invention

The present invention relates to a wheel bearing device with reduced abnormal noise during rotation.

2. Description of the Related Art

A hub unit 100 as illustrated in FIG. 11 is used as a wheel bearing device that rotatably supports a wheel of a vehicle. In the hub unit 100, a rotary shaft 103 including a flange 102 for mounting thereon a wheel 101 is rotatably supported by a double row angular contact ball bearing 104. The hub unit 100 is required to smoothly rotate for noise reduction while the vehicle is running. A driver may steer in the wrong direction while driving the vehicle to cause the wheel 101 to collide with a curb. In this case, if the collision applies a large load to the hub unit 100, indentations are generated on the raceway surface of the angular contact ball bearing 104, resulting in generation of abnormal noise while the vehicle is running.

The cause of the generation of the abnormal noise is considered to be that balls 105 override a shoulder 106, and thereby the indentations are generated in portions close to the shoulder 106 of the raceway surface 107. Thus, a structure is proposed that inhibits the balls from overriding the shoulder by setting the ratio of the height of the shoulder 106 to the diameter of the balls 105 to equal to or more than 0.25 to less than 0.50 (refer to Japanese Patent Application Publication No. 2012-31937 (JP 2012-31937 A)). Overriding the shoulder refers to a phenomenon in which a ball makes an elastic contact with a raceway surface, and a contact area elliptically spreading around the point of the contact (hereinafter, simply called a “contact area”) extends beyond the raceway surface.

Even in a bearing device in which the height of the shoulder is set to the extent described in JP 2012-31937 A, it has been observed that, in some cases, the abnormal noise still occurs depending on the amount of the impact load applied to the wheel. This is because the balls override the shoulder if an excessive thrust load is imposed on the wheel bearing device.

### SUMMARY OF THE INVENTION

It is an object of the present invention to prevent the generation of the abnormal noise of the wheel bearing device by completely preventing the generation of indentations caused by balls overriding the shoulder when an excessive thrust load is applied.

A wheel bearing device according to an aspect of the present invention is constitutionally characterized by including a fixed member having double row fixed raceway surfaces around its axis line, a rotary member having double row rotary raceway surfaces coaxial with and facing the fixed raceway surfaces, and double ball rows in each of which a plurality of balls are rollably disposed between the double row fixed-side raceway surfaces and the double row rotary raceway surfaces facing each other. In the wheel bearing device, in the rotary raceway surface associated with the ball row on a vehicle outer side, a generatrix on a contact angle side has a circular arc shape, and a shoulder on the vehicle outer side of the rotary raceway surface has a height larger than a curvature radius of the circular arc.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view of a hub unit, cut in the axis line direction thereof, that is a first embodiment of the present invention;

FIG. 2 is a magnified view of an essential part for illustrating a bearing portion of the first embodiment of the present invention;

FIG. 3 is a diagram illustrating the shape of an inner raceway surface in the hub unit of the first embodiment, and illustrating a method for grinding the inner raceway surface;

FIG. 4 is a diagram illustrating a state of a load applied to a wheel when the wheel collides with a curb;

FIG. 5 is a diagram illustrating a contact state between a ball and the raceway surface in the hub unit of the first embodiment when the wheel collides with the curb;

FIG. 6 is a diagram illustrating the shape of an inner raceway surface in a hub unit of a second embodiment of the present invention, and illustrating a method for grinding the inner raceway surface;

FIG. 7 is a diagram illustrating a contact state between the ball and the raceway surface in the hub unit of the second embodiment when the wheel collides with the curb;

FIG. 8 is a front view for illustrating an effect of the second embodiment, showing a positional relationship between the inner raceway surface and a grinding wheel during a grinding process;

FIG. 9 is a side view for illustrating the effect of the second embodiment, as viewed from the left of FIG. 8;

FIG. 10 is a view illustrating a sectional shape of the inner raceway surface in the second embodiment formed at a central angle of 70 degrees; and

FIG. 11 is a structural diagram of a conventional hub unit.

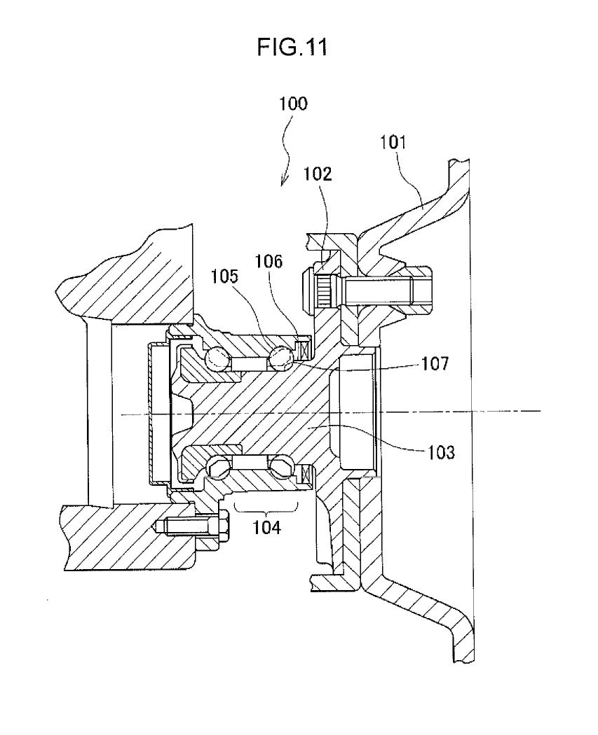

### DETAILED DESCRIPTION OF EMBODIMENTS

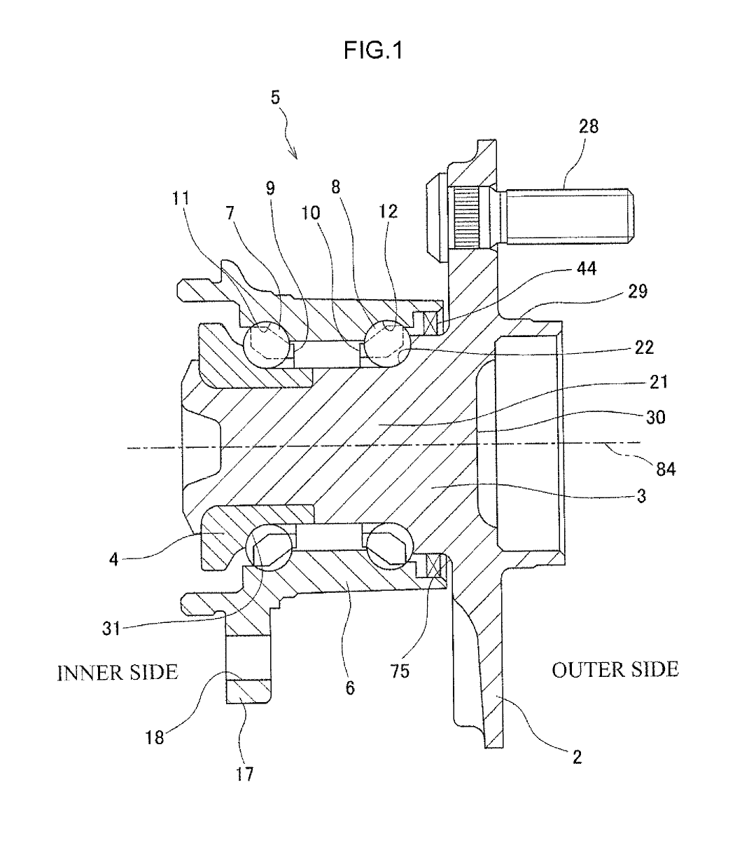

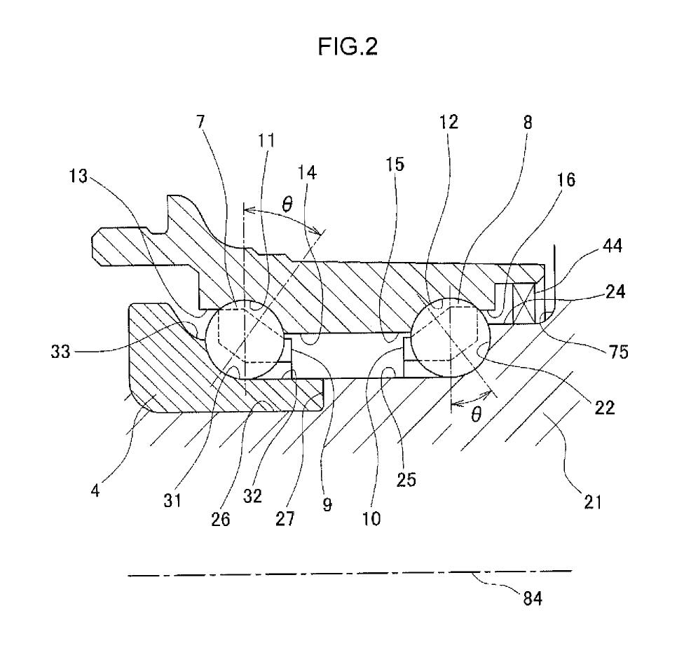

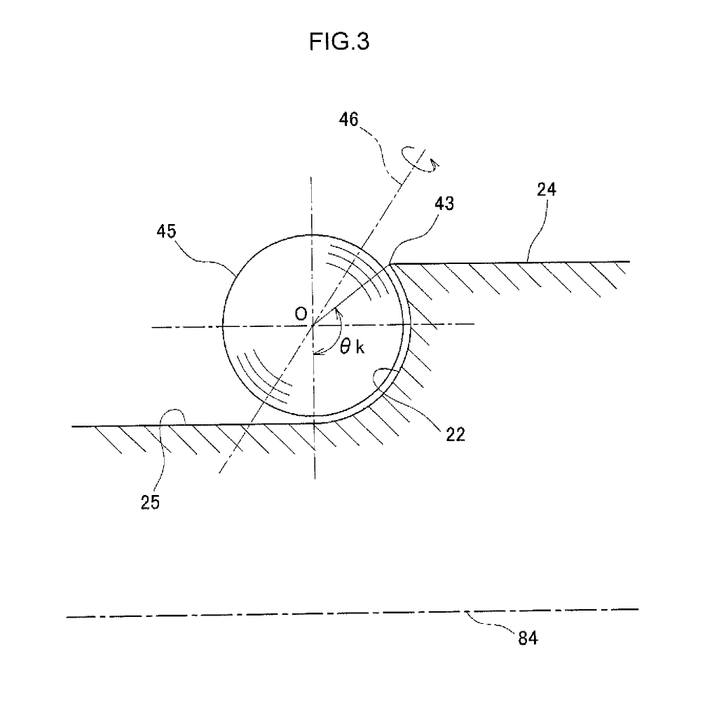

A hub unit 5 that is a first embodiment of the present invention will be described with reference to FIGS. 1 to 3. FIG. 1 is a sectional view of the hub unit 5, cut in the axis line direction thereof. FIG. 2 is a magnified view of an essential part for illustrating a bearing portion. FIG. 3 is a diagram illustrating the shape of an inner raceway surface in the hub unit 5 and illustrating a method for grinding the inner raceway surface. The right-hand side of FIG. 1 corresponds to an outer side of a vehicle when the hub unit 5 is mounted on the vehicle, so that the following description will be made assuming that the right side serves as an outer side and the left side serves as an inner side.

The hub unit 5 includes an outer ring 6 (fixed member), a rotary member 3, a plurality of balls 7, 8, and cages 9, 10. The outer ring 6 is fixed to the vehicle. The rotary member 3 is rotatably supported coaxially with the outer ring 6. The balls 7, 8 are rollably disposed between the outer ring 6 and the rotary member 3. The cages 9, 10 hold the balls 7, 8 so that the balls 7, 8 are arranged at predetermined intervals in the circumferential direction.

The outer ring 6 is made of carbon steel such as S55C. The outer ring 6 is integrally provided at the outer periphery thereof with a flange 17. Bolt holes 18 are formed through the flange 17 in the axis line direction. Bolts (not illustrated) are inserted into the bolt holes 18, and screw-tightened to a vehicle body so that the hub unit 5 is fixed to the vehicle.

A pair of outer raceway surfaces 11, 12 is provided at the inner periphery of the outer ring 6. The outer raceway surfaces 11, 12 are shaped by a turning process, and then, are quench-hardened by induction heat treatment to a hardness of approximately 60 HRC. Thereafter, the outer raceway surfaces 11, 12 are precisely finished by grinding and super finishing processes. The sectional shapes in the axis line direction of the outer raceway surfaces 11, 12 are circular arc shapes, and have curvature radiuses slightly larger than the radiuses of the balls 7, 8, respectively.

Each of the outer raceway surfaces 11, 12 has, on both sides thereof in the axial direction, cylindrical surfaces continuous with the raceway surface. Each of the cylindrical surfaces is hereinafter called a “shoulder”. Regarding also each inner raceway surface to be described below, the “shoulder” refers to a similar cylindrical surface. Shoulders 13, 14, 15, 16 are provided on both sides in respective axial directions of the outer raceway surfaces. Each of the shoulders 13, 14, 15, 16 has a cylindrical shape coaxial with the outer raceway surfaces 11, 12. At the outer raceway surface 11, the height of the shoulder 13 on the inner side is smaller than the height of the shoulder 14 on the outer side. At the outer raceway surface 12, the height of the shoulder 16 on the outer side is smaller than the height of the shoulder 15 on the inner side. The height of the shoulder at the outer raceway surface refers to a dimension in a direction orthogonal to the axis line of the outer ring 6 from the groove bottom (position where the diameter is largest) of the raceway surface.

The rotary member 3 is composed of a hub shaft 21 and an inner ring 4 pressed onto a shaft end on the inner side of the hub shaft 21.

The hub shaft 21 is made of carbon steel such as S55C. An angular inner raceway surface 22 is provided at the outer periphery of the hub shaft 21 coaxially with an axis line 84 of the hub shaft 21. The sectional shape in the axis line direction of the inner raceway surface 22 is a circular arc shape. A shoulder 24 is provided on the outer side of the inner raceway surface 22. The shoulder 24 has a cylindrical shape coaxial with the inner raceway surface 22. The height of the shoulder 24 is set larger than the radius of the balls 8. The height of the shoulder at the inner raceway surface refers to a radial dimension from the groove bottom (position where the diameter is smallest) of the inner raceway surface 22 to the outer periphery of the shoulder 24.

The inner raceway surface 22 is provided, on the inner side thereof, with a shaft portion 25 coaxial with the axis line 84 of the hub shaft 21. The shaft portion 25 has a cylindrical shape, and has an outside diameter dimension approximately equal to the minimum diameter of the inner raceway surface 22. A part of the shaft portion 25 forms a shoulder on the inner side of the inner raceway surface 22.

An inner ring fitting portion 26 having a diameter smaller than that of the shaft portion 25 is provided at the inner-side end of the shaft portion 25 coaxially with the shaft portion 25. The shaft portion 25 continues to the inner ring fitting portion 26 via a stepped portion 27 that is a flat surface orthogonal to the axis line 84.

A disc-like flange 2 is provided at an end on the outer side of the hub shaft 21. A portion where the shoulder 24 continues to the flange 2 is provided with a corner rounded portion 75 having a circular arc-like section in the axis line direction so as to ensure strength against a bending load applied to the flange 2. The flange 2 is provided with a plurality of bolts 28 for mounting thereon a wheel (not illustrated). A cylindrically shaped wheel mounting portion 29 is coaxially provided on the outer side face of the flange 2. A concave portion 30 is provided on the radial inner side of the wheel mounting portion 29.

The hub unit 5 is assembled to the vehicle, and then, the wheel is fit onto the wheel mounting portion 29. The wheel is then tightened with the bolts 28 so as to be fastened to the flange 2.

The inner ring 4 is made of bearing steel. An inner raceway surface 31 is provided at the outer periphery of the inner ring 4. Shoulders 32, 33 are provided on both sides in the axial direction of the inner raceway surface 31. The height of the shoulder 33 on the inner side is larger than the height of the shoulder 32 on the outer side. The sectional shape in the axis line direction of the inner raceway surface 31 is a circular arc shape. The curvature radius of the inner raceway surface 31 is slightly larger than the radius of the balls 7. The inner ring 4 is quench-hardened so that the whole thereof is hardened to a hardness of approximately 60 HRC. Thereafter, the inner raceway surface 31 is precisely finished by grinding and super-finishing.

The overall structure of the hub unit 5 will be described with reference to FIGS. 1 and 2. A seal 44 is installed in the outer ring 6, and then, the hub shaft 21 is assembled coaxially with the outer ring 6. The balls 7 and the balls 8 are respectively disposed between the outer raceway surface 11 and the inner raceway surface 31 facing each other and between the outer raceway surface 12 and the inner raceway surface 22 facing each other. The balls 7, 8 disposed on their corresponding raceway surfaces are retained by the cages 9, 10, respectively. The cages 9, 10 are made of resin. The cages 9, 10 are provided with pockets for housing the balls 7, 8, respectively, at constant intervals in their respective circumferential directions. Each of the pockets houses one of the balls 7, 8. Thus, two ball rows separated in the axis line direction are provided in the hub unit 5.

As illustrated in FIG. 2, in the two ball rows, each of the balls 7 contacts the outer and inner raceway surfaces 11 and 31 at a pair of points that are on the opposite sides of the center of the ball 7, and each of the balls 8 contacts the outer and inner raceway surfaces 12 and 22 at a pair of points that are on the opposite sides of the center of the ball 8. Each of these points is hereinafter called a “contact point”. Dimensions of various parts are set so that a straight line connecting together a pair of contact points of each of the balls 7, 8 forms a predetermined angle θ with a straight line that passes through the center of the ball 7, 8 and is orthogonal to the axis line 84 of the hub shaft 21. The angle θ is hereinafter called a “contact angle”. The contact angle is normally set approximately in the range of 30 degrees to 40 degrees. The directions of the contact angles in the two ball rows are set opposite to each other.

Thereafter, the inner ring 4 is pressed onto the inner ring fitting portion 26. Thereafter, the inner-side end of the hub shaft 21 is clinched to prevent the inner ring 4 from coming off. Thus, the assembly of the hub unit 5 is completed.

The shape of the inner raceway surface 22 will be described in detail with reference to FIG. 3. The inner raceway surface 22 is a surface whose section in the axis line direction of the hub shaft 21 is formed of one circular arc (a circular arc portion). The curvature radius of the circular arc portion is slightly larger than the radius of the balls 8.

A portion of the inner raceway surface 22 on the outside diameter side of the hub shaft 21 continues to the shoulder 24 via a corner 43. Forming the corner 43 at an acute angle is liable to cause problems of, for example, chipping the corner. However, as will be described later, in order to prevent the balls 8 from overriding the shoulder, the area of the inner raceway surface 22 needs to be set as large as possible. Given these factors, the size of a chamfer at the corner 43 is set to approximately 0.2 mm.

Thus, the inner raceway surface 22 is provided between a point tangent to the shaft portion 25 and the corner 43 such that the inner raceway surface 22 is formed of one circular arc that curves toward the outer side. The corner 43 is formed at one end in the axial direction of the shoulder 24, and the radial dimension from a groove bottom portion (point R) is equal to or larger than the curvature radius of the circular arc. Accordingly, a central angle θk for the circular arc (a central angle of a sector formed by both ends of the circular arc and a center of curvature O) is 90 degrees or larger.

The inner raceway surface 22 and the surface of the shoulder 24 are quench-hardened by the induction heat treatment to a hardness of approximately 60 HRC, and then are ground. As illustrated in FIG. 3, the inner raceway surface 22 can be ground with a spherical grinding wheel 45 having a radius of the same dimension as the curvature radius of the inner raceway surface 22, by rotating the spherical grinding wheel 45 about a central axis of rotation 46 tilted by a predetermined angle relative to the axis line.

Thereafter, the inner raceway surface 22 is precisely finished by super-finishing. The super-finishing process of the inner raceway surface 22 is performed using a super-finishing grinding wheel that has a center of oscillation in the same position as the center of curvature O of the circular arc forming the inner raceway surface 22. The inner raceway surface 22 is formed of one circular arc, so that the whole area of the inner raceway surface 22 can be precisely finished by oscillating the super-finishing grinding wheel along the generatrix of the inner raceway surface 22.

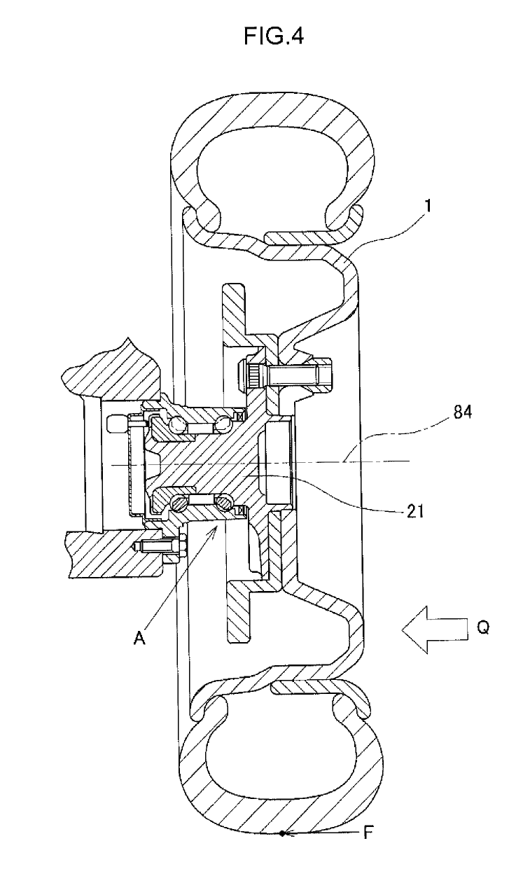

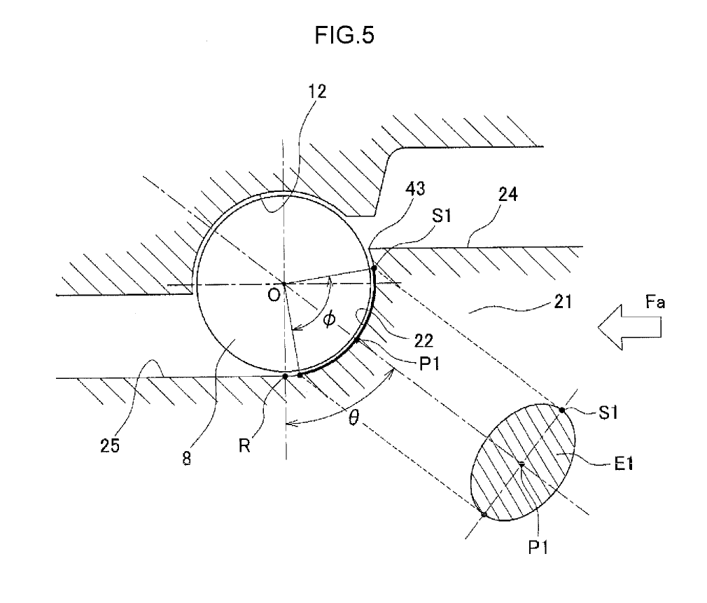

The following describes a contact state between the ball and the raceway surface when the wheel collides with a curb, with reference to FIGS. 4 and 5.

When the wheel 1 collides with the curb, a load Q is imposed on an outer peripheral portion of the wheel 1 in the direction indicated by a white arrow in FIG. 4. A lateral load F generated by a centrifugal force of the vehicle is imposed on a tire contact point during a normal vehicle turning. In contrast, the load Q is imposed on the outer peripheral portion of the wheel 1 that has a diameter smaller than the diameter of the tire. Thus, the radial distance between the point of application of the load and the axis line 84 during the collision with the curb is smaller than that during the normal turning. This causes a load having a large thrust component (thrust load Fa) to be imposed on the hub unit 5, so that the outer-side ball row (the part represented as “A” in FIG. 4) is placed under the severest use condition. The following describes the contact state between the ball 8 and the inner raceway surface 22 in the outer-side ball row.

When the wheel 1 collides with the curb, the magnitude of the load Q imposed on the wheel 1 greatly differs depending on, for example, the speed at the time of the collision. If an excessively large load is imposed, problems of, for example, deformation of components (such as a knuckle) other than the hub unit occur. To substantially continue to use the parts after the collision with the curb, it is appropriate to set the maximum of the load Q imposed on the wheel 1 to a value six times a vehicle weight (hereinafter, this value of the load is expressed as “6G”). The following description will be made assuming that the value of the load Q imposed during the collision with the curb is 6G.

FIG. 5 is a diagram illustrating the contact state between the ball 8 and the inner raceway surface 22 when the wheel 1 collides with the curb and the load Q of 6G is imposed on the wheel 1 so that the thrust load Fa indicated by a white arrow is imposed on the hub shaft 21. When the thrust load Fa is imposed, the ball 8 is pressed onto the inner raceway surface 22 and the outer raceway surface 12, and the ball 8 contacts the inner raceway surface 22 at a contact point P1. A contact area E1 is formed on the inner raceway surface 22 centered at the contact point P 1. The position of generation of the contact area E1 is indicated by a thick continuous line on the outline of the section of the inner raceway surface 22, and the shape of the contact area E1 as viewed from the direction of the contact angle is illustrated on the extension toward the contact angle side. The contact area E1 has an elliptical shape with its center at the contact point P1 and its major axis extending in the direction in which the generatrix of the inner raceway surface 22 extends.

The contact area increases as the force pressing the ball to the inner raceway surface increases. When the wheel 1 collides with the curb and the large thrust load Fa is imposed, a central angle φ of a sector formed by the center of curvature O and both ends of the contact area E1 (hereinafter, simply called a “central angle”) is larger than the amount of a central angle during normal running of the vehicle. In addition, the thrust load Fa is displaced the inner raceway surface 22 to the inner side relative to the outer raceway surface 12, so that the angle θ of the contact between the ball 8 and the inner raceway surface 22 is larger than the contact angle during the normal running of the vehicle.

Thus, during the collision with the curb, both the contact angle and the central angle are larger than those during the normal running of the vehicle. In some cases, this phenomenon makes the radial dimension from the groove bottom portion (point R) on the inner raceway surface 22 to the position of an end S1 at the radial outside of the contact area E1 larger than the curvature radius of the circular arc. When the height of the shoulder 24 is smaller than the radial dimension from groove bottom portion (point R) to the end S1, the contact area E1 extends beyond the inner raceway surface 22, so that the ball 8 comes in contact with the edge (in the position of the corner 43) of the inner raceway surface 22. The contact at the edge produces a surface pressure higher than that of contact between planes, so that an indentation is generated at a portion of the inner raceway surface 22 near the shoulder 24, and an indentation is also generated on the surface of the ball 8.

The indentation generated on the inner raceway surface has little influence on generation of abnormal noise. The reason for this is as follows: when the thrust load Fa is imposed an the hub shaft 21, the indentation is generated in a position where the contact angle is larger than that during the normal running. Thus, when the normal running is restored, the contact angle returns to the original small value, so that the contact area E1 between the ball 8 and the inner raceway surface 22 moves away from the position of generation of the indentation.

However, after the indentation is generated on the surface of the ball 8 and then the normal running is restored, the indentation inevitably passes through the contact points between the ball 8 and the inner and the outer raceway surfaces 22 and 12 when the hub shaft rotates and thereby the ball 8 rolls. This results in generation of abnormal noise, and that is why the indentation needs to be surely prevented from occurring on the surface of the ball 8.

In the hub unit 5 of the first embodiment, the height of the shoulder 24 on the vehicle outer side of the inner raceway surface 22 is larger than the curvature radius of the circular arc forming the inner raceway surface 22. This allows the inner raceway surface 22 continuing to the shoulder 24 to be fainted so that the radial dimension from the groove bottom portion (point R) to an end at the radial outside of the inner raceway surface 22 is larger than the curvature radius of the circular arc. As a result, the position of the end at the radial outside of the inner raceway surface 22 can be set radially outside the end S1 of the contact area E1. This setting prevents the contact area E1 from extending beyond the end at the radial outside of the inner raceway surface 22. With this configuration, the edge of the inner raceway surface 22 is prevented from coming in contact with the ball 8. As a result, no indentations are generated at the portion of the inner raceway surface 22 near the shoulder 24 or on the surface of the ball 8.

In addition, the inner raceway surface 22 in the first embodiment is formed of one circular arc up to the corner 43 on the outer side of the center of curvature O in the axis line direction. This causes the contact area between the ball 8 and the inner raceway surface 22 to be always formed at the circular arc portion of the inner raceway surface 22. This makes the axis length of the contact ellipse longer and thereby the contact area larger, so that the contact pressure between the ball 8 and the inner raceway surface 22 can be reduced. Thus, the generation of the indentation of the inner raceway surface 22 can surely be prevented.

As has been described above, when the wheel collides with the curb, the hub unit 5 of the first embodiment can surely prevent the generation of abnormal noise by preventing the indentations from occurring due to the ball overriding the shoulder.

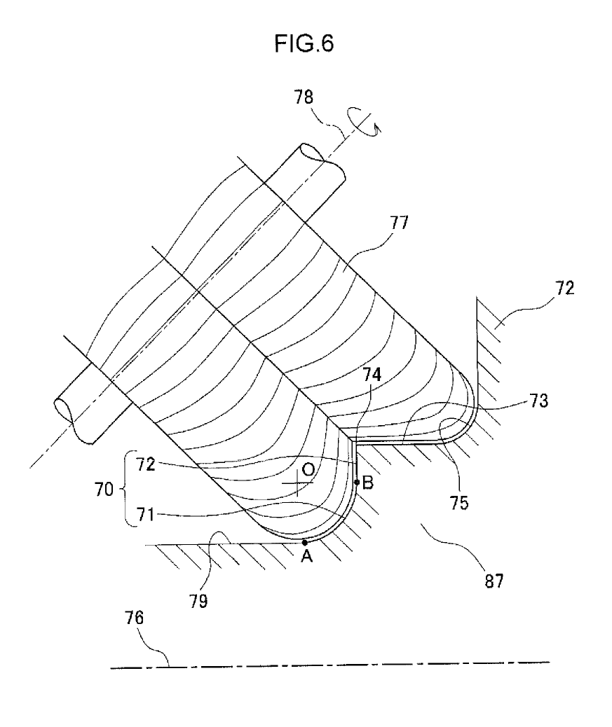

A second embodiment of the present invention will be described. The shape of an inner raceway surface in the second embodiment will be described in detail with reference to FIG. 6. A hub unit of the second embodiment differs from that of the first embodiment only in the shape of the inner raceway surface formed in the hub unit. The other portions have the same forms as those of the first embodiment, so that description of the common portions will be omitted. The same numerals are given to the common components.

As illustrated in FIG. 6, an inner raceway surface 70 is provided at the outer periphery of a hub shaft 87 coaxially with an axis line 76. The sectional shape in the axis line direction of the inner raceway surface 70 is formed by a circular arc portion 71 and a linear portion 72. An end on the small-diameter side of the circular arc portion 71 continues to a shaft portion 79, An outline of the shaft portion 79 corresponds to a tangent line to the circular arc portion 71. The shaft portion 79 and the circular arc portion 71 are tangent to each other at a groove bottom portion (point A). The curvature radius of the circular arc portion 71 is slightly larger than the radius of the ball 8. The circular arc portion 71 is provided on the outer side of the groove bottom portion (point A) on the inner raceway surface 70. The linear portion 72 is a tangent line tangent to the circular arc portion 71 at a point B. The radial dimension from the groove bottom portion (point A) to the point B is the same as the radial dimension from the groove bottom portion (point A) to the center of curvature O of the circular arc portion 71. As is clear from this relationship, the linear portion 72 is orthogonal to the axis line 76.

Thus, the height of a shoulder 73 on the vehicle outer side of the inner raceway surface 70 is larger than the curvature radius of the circular arc portion 71.

An end in the direction toward the outer periphery of the inner raceway surface 70 (that is, an end on the outer periphery side of the linear portion 72) continues to the shoulder 73 having a cylindrical shape. A corner 74 where the linear portion 72 continues to the shoulder 73 is slightly chamfered. This is because a sharp corner on the corner 74, if formed, is liable to cause problems of, for example, chipping of the sharp corner. However, in order to prevent the ball 8 from overriding the shoulder, the area of the inner raceway surface 70 needs to be ensured, so that the size of the chamfer at the corner 74 is set to approximately 0.2 mm. A portion where the shoulder 73 continues to the flange 2 provided on the outer side thereof is provided with a corner rounded portion 75 having a circular arc-like section in the axis line direction so as to ensure strength against a bending load applied to the flange 2.

A method for processing the inner raceway surface will be described with reference to FIG. 6. The inner raceway surface 70 and the surface of the shoulder 73 are hardened by the induction heat treatment to a hardness of approximately 60 HRC, and then are ground. This grinding process is performed by causing a disc-shaped grinding wheel 77 to abut on a portion to be processed of the hub shaft 87 while slowly rotating the hub shaft 87 about the axis line 76 thereof. A central axis of rotation 78 of the grinding wheel 77 is tilted by 45 degrees relative to the axis line 76 of the hub shaft 87. The outer periphery of the grinding wheel 77 is formed into the same shape as the profile of the hub shaft 87 extending from the inner raceway surface 70 to the corner rounded portion 75, which range is ground all at the same time.

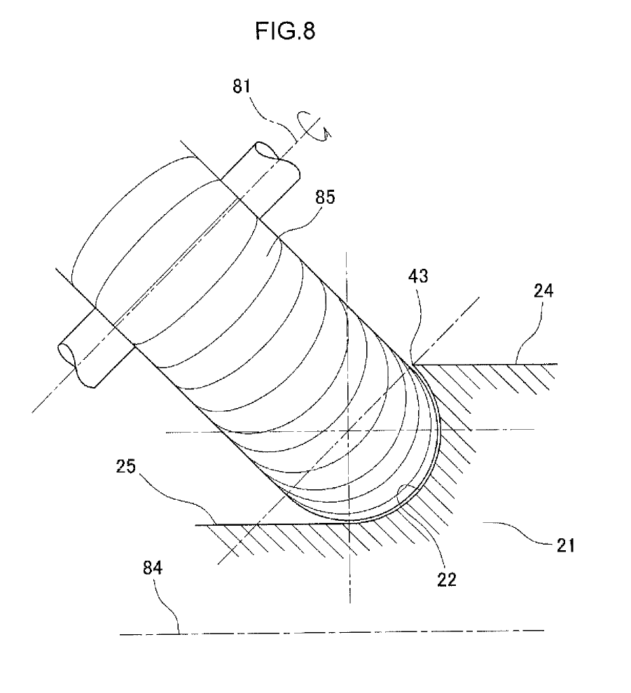

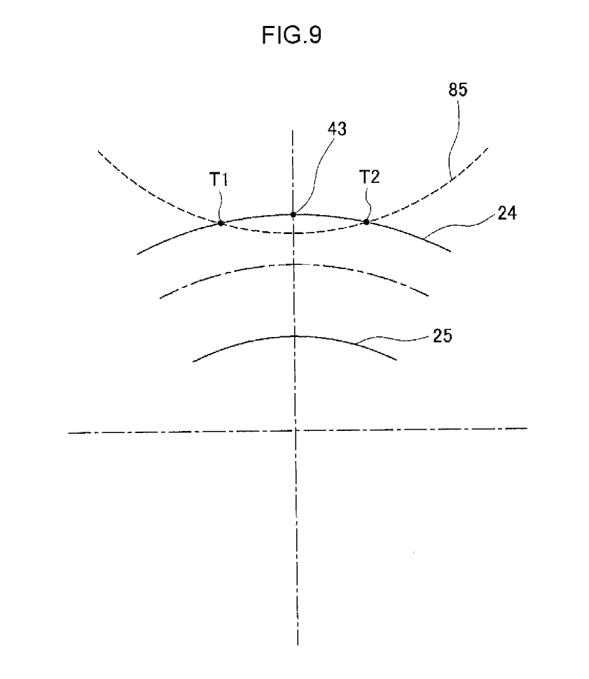

The second embodiment is advantageous over the first embodiment in that the inner raceway surface 70 can be more efficiently ground. This advantage will first be described. To facilitate understanding, with reference to FIGS. 8 and 9, description will be made of an example of a case in which the inner raceway surface 22 of the hub unit of the first embodiment is processed with the grinding method used in the second embodiment described above. The inner raceway surface 22 is fanned by the circular arc having the central angle Ok larger than 90 degrees (e.g., 135 degrees). FIG. 8 is a front view illustrating a positional relationship between the inner raceway surface 22 and a grinding wheel 85 during the grinding process. FIG. 9 is a side view from the left of FIG. 8, showing a processing state of the inner raceway surface 22 illustrated in FIG. 8.

As illustrated in FIG. 8, the outer periphery of the disc-shaped grinding wheel 85 is formed into the same shape as that of the profile of the inner raceway surface 22, and the inner raceway surface 22 is ground with a central axis of rotation 81 of the grinding wheel 85 tilted by 45 degrees relative to the axis line 84 of the hub shaft 21. During this process, the hub shaft 21 is slowly rotated about the axis line 84. Using this grinding method can increase the circumferential speed of the grinding surface, thereby markedly improving the grinding efficiency compared to the case of processing with the spherical grinding wheel 45 having the same radius as the curvature radius of the inner raceway surface 22.

When the height of the shoulder 24 is larger than the curvature radius of the circular arc portion forming the inner raceway surface 22, the inner raceway surface 22 is formed so that the position in the axis line direction of the corner 43 where the inner raceway surface 22 continues to the shoulder 24 overlaps the position in the axis line direction of the grinding wheel 85. As a result, rotating the hub shaft 21 about the axis line 84 causes the corner 43 to interfere with the grinding wheel 85 at T1 and T2 in FIG. 9. In FIG. 9, a dashed line indicates the trajectory of a portion of the grinding wheel 85, which interferes with the corner 43. As a result, the corner 43 is ground off and thus the area of the inner raceway surface 22 decreases, so that the ball 8 becomes more likely to override the shoulder. Thus, the interference needs to be avoided.

Employing the shape of the inner raceway surface 22 according to the second embodiment can avoid the interference described above. In the second embodiment, the linear portion 72 is provided so as to extend in the direction orthogonal to the axis line 76, so that the corner 74 where the inner raceway surface 70 continues to the shoulder 73 does not overlap the grinding wheel 77 in the axis line direction. As a result, the corner 74 does not interfere with the grinding wheel 77, so that the processing efficiency in the process of grinding the inner raceway surface can be markedly improved.

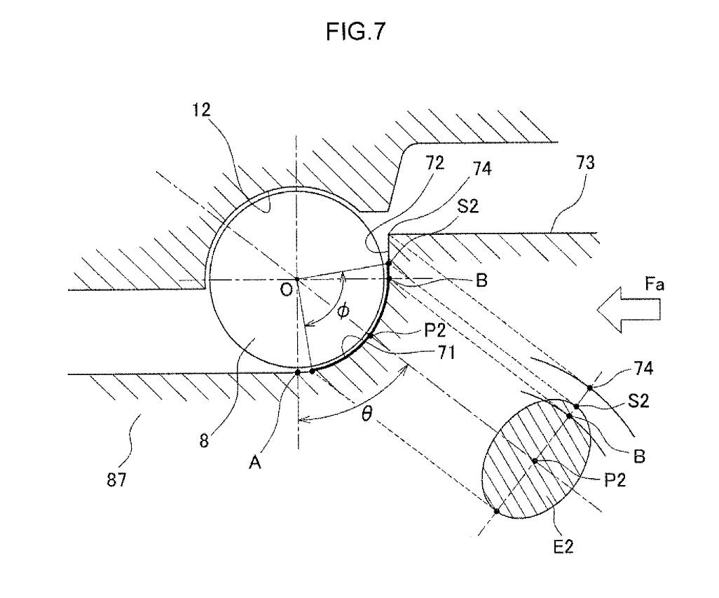

With reference to FIG. 7, the following describes the contact state between the ball 8 and the inner raceway surface 70 when the wheel mounted on the hub unit of the second embodiment collides with the curb and the load Q of 6G is imposed on the wheel 1 (refer to FIG. 4). When the load Q is imposed on the wheel 1, the thrust load Fa is imposed on the hub shaft 87, as indicated by a white arrow in FIG. 7. In this case, the ball 8 is pressed onto the inner raceway surface 70, and a contact area E2 is formed around a contact point P2 between the ball 8 and the inner raceway surface 70. The position of generation of the contact area E2 is indicated by a thick continuous line on the outline of the section of the inner raceway surface 70 in the axis line direction, and the shape of the contact area E2 as viewed from the direction of the contact angle is illustrated on the extension toward the contact angle side, The contact area E2 has a generally elliptical shape with its center at the contact point P2 and its major axis extending in the direction in which the generatrix of the inner raceway surface 70 extends.

When the wheel 1 collides with the curb and the thrust load Fa is imposed on the hub shaft 87, the contact area E2 is larger than the contact area during the normal running of the vehicle. In addition, when the thrust load Fa is imposed on the hub shaft 87, the inner raceway surface 70 is displaced to the inner side relative to the outer raceway surface 12, so that the angle θ between the ball 8 and the inner raceway surface 70 is larger than the contact angle during the normal running of the vehicle. Thus, in some cases, the collision with the curb makes the radial dimension from the groove bottom portion (point A) on the inner raceway surface 70 to the position of an end S2 at the radial outside of the contact area E2 larger than the curvature radius of the circular arc. As a result, the contact area E2 is formed to extend from the circular arc portion 71 to the linear portion 72.

In the hub unit of the second embodiment, the height of the shoulder 73 on the vehicle outer side of the inner raceway surface 70 is larger than the curvature radius of the circular arc forming the inner raceway surface 70. This dimensional relationship allows the inner raceway surface 70 to be formed so that the radial dimension from the groove bottom portion (point A) to the position of an end at the radial outside of the inner raceway surface 70 is larger than the curvature radius of the circular arc. As a result, the dimension from the groove bottom portion (point A) to the position of the end at the radial outside of the inner raceway surface 70 can be set larger than the dimension from the groove bottom portion (point A) to the end S2 of the contact area E2. This setting prevents the contact area E2 from extending beyond the end at the radial outside of the inner raceway surface 70. With the configuration, the edge of the inner raceway surface 70 is prevented from coming in contact with the ball 8. As a result, no indentations are generated at a portion of the inner raceway surface 70 near the shoulder 73 or on the surface of the ball 8.

The linear portion 72 is a tangent line to the circular arc portion 71, so that the generatrix of the inner raceway surface 70 has a smoothly changing curvature radius. Thus, what is called a stress concentration does not occur at the joint between the linear portion 72 and the circular arc portion 71, so that the contact pressure is uniformed, thus allowing the maximum surface pressure to be kept low. Thus, the generation of the indentation on the raceway surface can surely be prevented.

The direction in which the linear portion 72 extends is not limited to the direction orthogonal to the axis line 76. The scope of the present invention includes slightly tilting the linear portion 72 toward the outer side in order to surely avoid interference between the grinding wheel 77 and the corner 74.

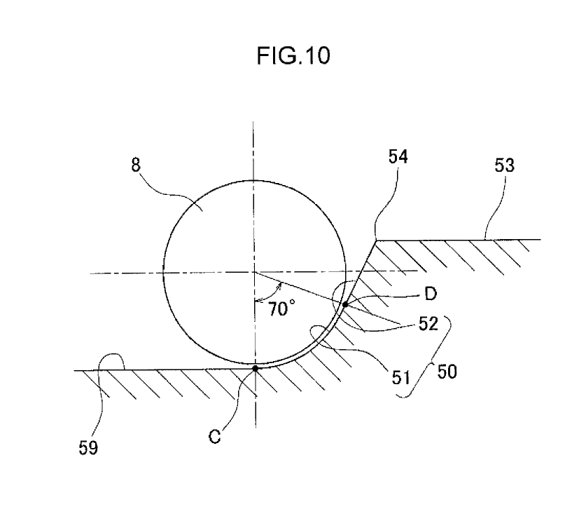

When tilting the linear portion 72 as described above, increasing the tilt angle increases the area of a portion of the contact area E2 formed in the linear portion 72. In the linear portion 72, the axis length of the contact ellipse forming the contact area decreases, so that the contact area decreases and the contact pressure increases. To prevent occurrence of problems, such as flaking, on the inner raceway surface 70, the tilt angle (angle formed by the axis line 76 and the linear portion 72) is preferably set to 70 degrees or larger. FIG. 10 illustrates the shape of an inner raceway surface 50 when the inner raceway surface 50 is formed at a tilt angle of 70 degrees. The inner raceway surface 50 is formed by a circular arc portion 51 and a linear portion 52. The circular arc portion 51 is formed between points C and D, and has a central angle of 70 degrees. The linear portion 52 is a tangent line tangent to the circular arc portion 51 at the point D. A shoulder 53 is provided on the outer side of the inner raceway surface 50. The inner raceway surface 50 continues to the shoulder 53 at the corner 54. Thus, the shoulder 53 is provided so that the height thereof is larger than the curvature radius of the circular arc portion 51.

As has been described above, when the wheel collides with the curb, the hub unit of the second embodiment can surely prevent the generation of abnormal noise by preventing the indentations due to the balls overriding the shoulder.

With the present invention, it is possible to completely prevent balls from overriding the shoulder, thereby preventing generation of abnormal noise of a wheel bearing device, when an excessive thrust load is applied.

What is claimed is:

1. A wheel bearing device comprising:
a fixed member having double row fixed raceway surfaces around its axis line;
a rotary member having double row rotary raceway surfaces coaxial with and facing the fixed raceway surfaces; and
double ball rows in each of which a plurality of balls are rollably disposed between the double row fixed-side raceway surfaces and the double row rotary raceway surfaces facing each other, wherein
in the rotary raceway surface associated with the ball row on a vehicle outer side, a generatrix on a contact angle side has a circular arc shape, and a shoulder on the vehicle outer side of the rotary raceway surface has a height larger than a curvature radius of the circular arc.

2. The wheel bearing device according to claim 1, wherein
the rotary raceway surface associated with the ball row on the vehicle outer side is formed by one circular arc, and
the circular arc includes a circular arc portion having a central angle of 90 degrees or more on the vehicle outer side of a center of curvature of the circular arc.

3. The wheel bearing device according to claim 1, wherein
the rotary raceway surface associated with the ball row on the vehicle outer side includes a circular arc portion and a linear portion that is tangent to the circular arc portion at a radial outside of the circular arc, and
the linear portion and the axis line together form an angle of 90 degrees or less on the vehicle outer side of the circular arc portion.
